(19) United States
(12) Patent Application Publication
(10) Pub. No.: US 2007/0122661 A1
(43) Pub. Date: May 31, 2007

(54) Methods and apparatus for a hybrid power source

(75) Inventors: Kevin Cordes, Miller Place, NY (US); Christopher Paul, Bayport, NY (US); Joe Cabana, Centereach, NY (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/290,335

(22) Filed: Nov. 29, 2005

(51) Int. Cl. H01M 16/00; H01M 8/10

(52) U.S. Cl. 429/9; 429/30

(57) ABSTRACT

A hybrid power supply used in a device generally includes a fuel cell plant configured to produce a DC voltage via electrochemical conversion of a fuel, a fuel reservoir attached to the fuel cell plant for supplying the fuel to the fuel cell plant, and a rechargeable battery electrically coupled to the fuel cell plant. The fuel cell plant keeps rechargeable battery substantially charged while rechargeable battery accommodates load variations resulting from operation of the device. In this way, the hybrid power supply maintains operation of the device when the fuel reservoir is removed.

### TECHNICAL FIELD

The present invention generally relates to power sources and, more particularly, to improved power supplies incorporating fuel cell technology.

### BACKGROUND

During the normal course of operation, a mobile device—for example, a mobile terminal, a personal data assistant (PDA), or the like—will deplete its main power source. As such devices typically include important information such as user data, configuration values and state information stored in some form of memory, it is desirable to allow the main power source to be swapped out without disrupting storage of this information.

To maintain memory, conventional mobile devices generally incorporate some form of dedicated power supply, for example, a battery or ultra-capacitor (also referred to as a “supercap”). These types of power sources are often used in conjunction with support circuitry configured to charge the backup power source and regulate its output. This support circuitry takes up additional board space and can add significant expense to the unit.

In addition, such known power sources generally operate at a low power level. That is, the battery in such systems is designed merely to maintain certain information stored in the device's various memory components; it is not designed to supply enough power to allow the device to be used in a normal operation mode. Rather, the device is typically powered down or placed in stand-by mode in order to remove the main power supply. This leads to inconvenience and loss of productivity.

Accordingly, there is a need for systems and methods that overcome these and other limitations of the prior art.

### BRIEF SUMMARY

A hybrid power supply in accordance the present invention generally includes a fuel cell plant with a reservoir (e.g., a direct methanol fuel cell (DMFC) with a methanol-filled reservoir) configured to produce a DC voltage via electrochemical conversion of a fuel. A rechargeable battery (e.g., a lithium-ion battery) is electrically coupled to the fuel cell plant. The fuel cell plant keeps the rechargeable battery substantially charged while the rechargeable battery accommodates load variations resulting from operation of the device. In this way, the hybrid power supply maintains operation of the device even when the reservoir is removed.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a schematic overview of a device with a hybrid power supply in accordance with one embodiment of the present invention;

FIG. 2 is a schematic overview of the device of FIG. 1 with fuel reservoir removed; and

FIG. 3 is a schematic overview of a typical direct methanol fuel cell.

### DETAILED DESCRIPTION

The following detailed description is merely illustrative in nature and is not intended to limit the invention or the application and uses of the invention. Furthermore, there is no intention to be bound by any expressed or implied theory presented in the preceding technical field, background, brief summary or the following detailed description.

The detailed description may also include functional and/or logical block components and various processing steps. It should be appreciated that such block components may be realized by any number of hardware, software, and/or firmware components configured to perform the specified functions.

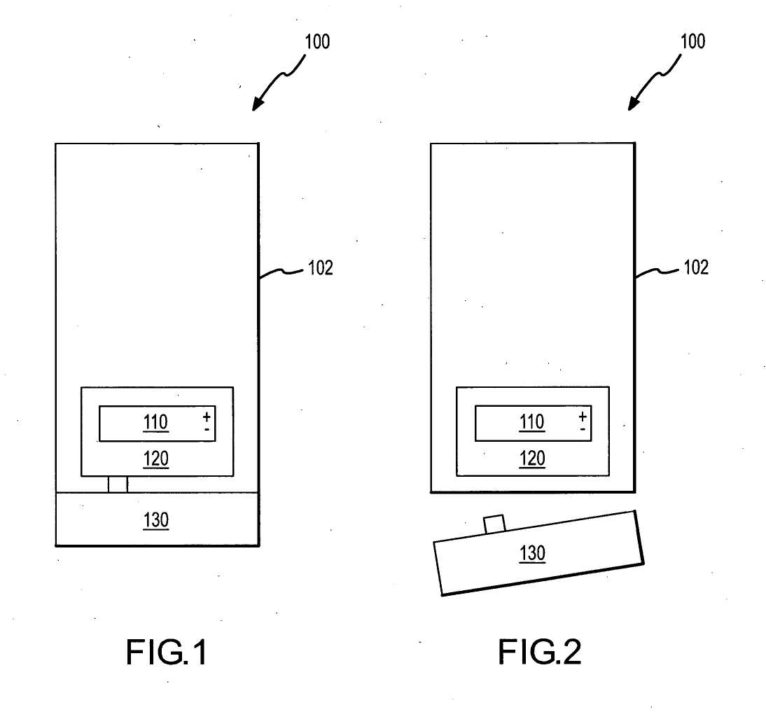

Referring to FIG. 1, a device 100 incorporating a hybrid power supply in accordance with one embodiment of the present invention generally includes a fuel cell plant (or simply “plant”) 120 communicating with and receiving fuel from a fuel reservoir (or “reservoir”) 130. A rechargeable battery (or “battery”) 110 is electrically coupled to fuel cell plant 120. Rechargeable battery 110, fuel reservoir 130, and fuel cell plant 120 are collectively referred to herein as the “power supply” and/or the “hybrid power supply.”

The available energy of a typical battery diminishes over a relatively short time (approximately 8 hours), while the available energy of a fuel cell lasts much longer (greater than 20 hours). On the other hand, fuel cells have difficulty in handling load fluctuations—a difficulty that batteries do not share. A hybrid power source in accordance with the present invention therefore combines these two technologies such that fuel cell plant 120 produces a DC voltage that charges battery 110 and, at the same time, battery 110 accommodates variations in load current provided to device 100. The hybrid power supply of the present invention thus allows reservoir 130 to be removed from device 102 without significantly sacrificing operational capability.

In one embodiment, fuel reservoir 130 may be removed from housing 102 to simplify changing of the reservoir when, for example, the fuel in reservoir 130 has been depleted. Such an embodiment is shown schematically in FIG. 2, which illustrates device 100 with reservoir 130 removed from housing 102. Attachment of reservoir 130 to housing 102 may be accomplished in accordance with any convenient method. In one embodiment, a key/lock system or other security arrangement is employed to prevent accidental or unauthorized removal of reservoir 130.

Having thus given an overview of a hybrid power supply in accordance with the present invention, a detailed description of the various components will now be provided.

Fuel cell plant 120 includes any component capable of producing electrical energy via electrochemical conversion of a fuel, which is typically a liquid. In this regard, many types of fuel cells may be used in conjunction with the present invention. In one embodiment, fuel cell plant 120 is a direct methanol fuel cell (DMFC).

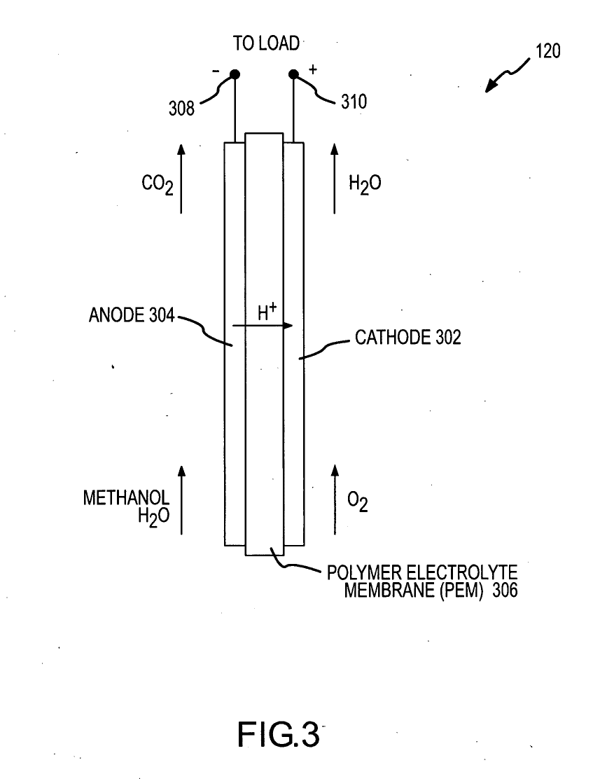

A DMFC is a proton-exchange type fuel cell that uses a polymer membrane as an electrolyte and relies upon the oxidation of methanol on a catalyst layer to form carbon dioxide. Referring to FIG. 3, a DMFC 120 generally includes an anode electrode 304, a cathode electrode 302, and respective terminals 308 and 310. Cathode 302 and anode 304 are separated by a membrane 306, e.g., a polymer electrolyte membrane (PEM) 306. During operation, methanol and water are supplied to anode 304, producing carbon-dioxide, while oxygen is supplied to cathode 302, producing water and resulting in the transport of protons (H+) across membrane 306. Specifically, the half reactions within DMFC 120 are:
Anode: CH₃OH+H₂O→CO₂+6H⁺+6e⁻
Cathode: 1.50₂+6H⁺+6e⁻→3H₂O
and the net reaction is:
CH₃OH+1.50₂→CO₂+2H₂O

Thus, DMFC 120 uses methanol as a fuel, producing electrical energy, carbon dioxide, and water. In this regard, while the illustrated embodiment is discussed in the context of a DMFC, the present invention contemplates the use of other fuel cell types, including, for example, alkaline fuel cells, molten-carbonate fuel cells, phosphoric-acid fuel cells, direct borohydride fuel cells, solid-oxide fuel cells, zinc fuel cells, and the like.

Terminals 308 and 310 of fuel cell 120 are connected to a load external to the cell. In accordance with one embodiment of the present invention, terminals 308 and 310 are coupled to a rechargeable battery (e.g., battery 110 in FIG. 1) as well as the internal electrical load associated with device 100. That is, when reservoir 130 is removed from device 100, battery 110 takes over and provides the required DC power in conjunction with fuel cell 120. The positive and negative terminals of battery 110 are preferably coupled, directly or indirectly, to the anode and cathode of fuel cell 120.

When battery 110 is being charged, a voltage is applied across its terminals to reverse the chemical reaction that would typically take place during normal operation of the battery (i.e., when the battery is acting as a standard voltaic cell.). Battery 110 is preferably electrically coupled to fuel cell plant 120 (and other optional control electronics, not shown) such that fuel cell plant 120 keeps battery 110 substantially charged. In one embodiment of the present invention, the output of fuel cell 120 feeds a battery charger circuit of the type known in the art, which would then feed into battery 110.

Battery 110 is any suitable type of rechargeable battery now known or later developed. In one embodiment, for example, battery 110 is a rechargeable lithium-ion battery. Other battery-types may also be used, however, including various nickel-cadmium batteries, nickel-metal-hydride batteries, lithium-polymer batteries, and the like. Furthermore, battery 110 may include two or more batteries configured in parallel or series, depending upon the power requirements of the application.

Battery 110 is selected in accordance with known criterion depending upon, for example, required power, required voltage, anticipated recharge cycles, etc. For example, device 100 will typically have known operational power requirements for normal loads, peak loads, and loads necessary to maintain some minimum level of storage (i.e., to maintain settings and data resident in the device). In this regard, battery 110 and fuel plant 120 are preferably selected such that they are, in combination, capable of supplying power substantially equal to the operational power requirements of the device. That is, it is preferable for the device to be fully-operational even when the reservoir is removed.

In one embodiment, battery 110 has a nominal capacity of approximately 400 to 500 mA*hr and a supply voltage of from about 3.0 to 5.0 volts. Such a battery is of particular utility in mobile devices of the type having an input, an LCD screen, and other such components that must be carried around to locations where an external power source is not available.

While at least one example embodiment has been presented in the foregoing detailed description, it should be appreciated that a vast number of variations exist. It should also be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A power source for a mobile device, said power source comprising:
a fuel cell plant configured to produce a DC voltage via electrochemical conversion of a fuel,
a fuel reservoir coupled to said fuel cell plant for supplying said fuel to said fuel cell plant;
a rechargeable battery coupled to said fuel cell plant.

2. The power source of claim 1, wherein said fuel cell plant is a Direct Methanol Fuel Cell (DMFC), and wherein said fuel reservoir contains methanol.

3. The power source of claim 1, wherein said fuel cell plant is a proton-exchange type fuel cell.

4. The power source of claim 1, wherein said rechargeable battery is a lithium-ion battery.

5. The power source of claim 1, wherein said fuel cell plant and said rechargeable battery are configured such that said rechargeable battery accommodates variations in load current provided to the mobile device.

6. The power source of claim 1, wherein the mobile device has an operational power requirement, and wherein the power source is capable of supplying a power substantially equal to said operational power requirement.

7. The power source of claim 1, wherein the mobile device has an operational power requirement of between 1.0 and 25.0 watts.

8. The power source of claim 1, wherein said rechargeable battery has a nominal voltage of approximately 3.0 to 5.0 volts.

9. The power source of claim 1, wherein said rechargeable battery has a nominal capacity of approximately 100 to 4400 mA*hr.

10. The power source of claim 1, wherein the mobile device has a housing, and wherein said removeable fuel reservoir is configured to removeably attach to said housing, and includes a fuel path to supply a fuel from said fuel reservoir to said fuel cell plant.

11. A mobile device comprising:
a housing;
a power source provided within said housing, said power source comprising a direct methanol fuel cell (DMFC) plant having an anode and a cathode, a fuel reservoir removeably attached to said fuel cell plant for supplying said fuel to said fuel cell plant, and a rechargeable battery coupled to said anode and cathode of said fuel cell plant via a charging circuit.

12. The mobile device of claim 11, wherein said rechargeable battery is a lithium-ion battery.

13. The mobile device of claim 11, wherein said fuel cell plant and said rechargeable battery are configured such that said rechargeable battery accommodates variations in load current provided to the mobile device.

14. The mobile device of claim 11, wherein the mobile device has an operational power requirement, and wherein said power source is capable of supplying a power substantially equal to said operational power requirement.

15. The mobile device of claim 11, further comprising a battery charger circuit coupled to said fuel cell plant and said rechargeable battery.
